(19) United States
(12) Patent Application Publication
(10) Pub. No.: US 2006/0029857 A1
(43) Pub. Date: Feb. 9, 2006

(54) Carbon aerogel and xerogel fuels for fuel cells and batteries

(75) Inventors: Nerine J. Cherepy, Oakland, CA (US); Alan F. Jankowski, Livermore, CA (US); Thomas M. Tillotson, Tracy, CA (US); Kyle Fiet, Corpus Christi, TX (US)

Correspondence Address: Eddie E. Scott;Assistant Laboratory Counsel, Lawrence Livermore National Laboratory, L-703, P.O. Box 808, Livermore, CA, 94551, US

(73) Assignee: The Regents of the University of California

(21) Appl. No.: 10/913,573

(22) Filed: Aug. 5, 2004

(51) Int. Cl. H01M 4/86; H01M 4/02; H01M 4/62; H01M 4/96

(52) U.S. Cl. 429/40; 429/209; 429/44; 429/232

(57) ABSTRACT

A fuel cell or battery comprises a fuel cell or battery having an anode component. The anode component comprises an aerogel or xerogel.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to fuel cells and batteries and more particularly to carbon aerogel and xerogel fuels for fuel cells and batteries.

2. State of Technology

U.S. Pat. No. 2003/0072989 by Choong Gon Lee et al for a molten carbonate fuel cell, published Apr. 17, 2003, in paragraph [0004] provides the following state of technology information: “A fuel cell is a power generating apparatus for converting chemical energy into electrical energy using an electrochemical reaction, and is highlighted as a new electrical energy source, because of being an environmental friendly apparatus and having a high power-generating efficiency. Such a fuel cell has a characteristic of continuously generating the power by supplying a fuel through an oxidation reaction of hydrogen and a reduction reaction of oxygen in the air.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a fuel cell or battery. The fuel cell or battery includes an anode component. The anode component comprises an aerogel or xerogel. The present invention has use in carbon/air batteries, carbon-fueled fuel cells, and high-rate carbon fuel cells, as well as other fuel cells and batteries.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates an embodiment of a battery system constructed in accordance with the present invention FIG. 2 illustrates an embodiment of a carbon fuel cell system constructed in accordance with the present invention.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

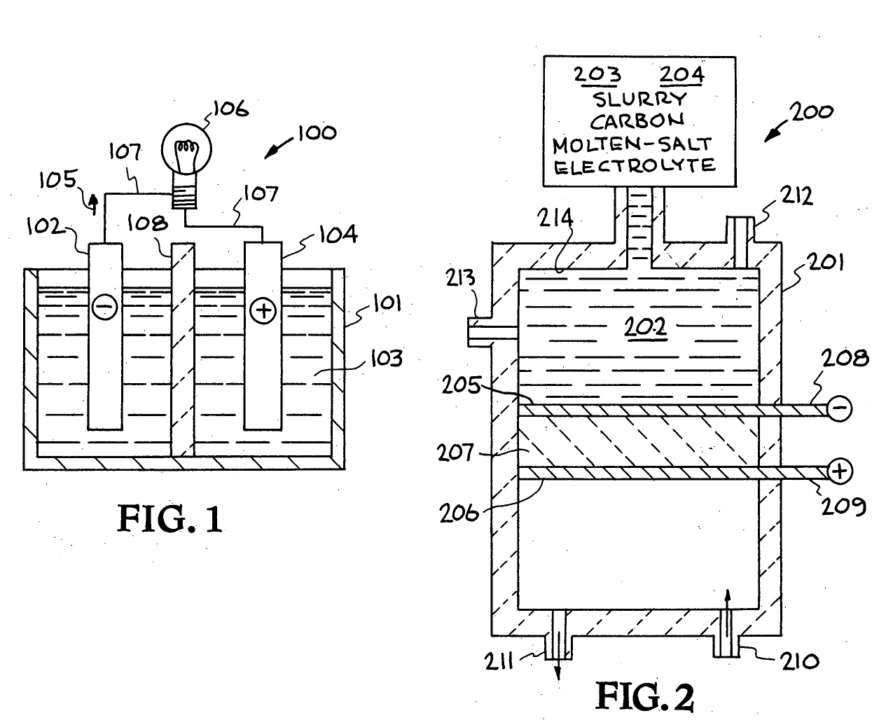

Referring now to FIG. 1, an embodiment of a battery system constructed in accordance with the present invention is illustrated. The battery system is designated generally by the reference numeral 100. The battery system 100 comprises a battery housing 101 that contains an anode 102, a cathode 104, and an electrolyte 103. A ceramic separator 108 may be positioned between the anode 102 and the cathode 104. A current 105 is produce in conductors 107 connected to the anode 102 and the cathode 104. The battery 100 produces power for a power consuming device such as the bulb 106.

The anode 104 is constructed of carbons prepared by sol-gel techniques. The reactivity of carbons in form of aerogel microspheres, aerogels or xerogels are expected to be general, regardless of whether they are prepared in particulate form, pellet form, or as a monolith. Carbon aerogels/xerogels are composed of covalently bonded, nanometer-sized particles that are arranged in a 3-dimensional network. These materials have high porosity (>50%) pores that are less than 100 nm in diameter, and have surface areas that range from 400 to 1000 m²/g and high electrical conductivity (25-100 S/cm). The pyrolysis of a resorcinol precursor in the presence of a catalyst is used to produce a variety of carbon materials. The ratio of resorcinol to catalyst will determine structural parameters, such as primary particle size and secondary aggregate size. Sol-gel derived carbon exhibits three properties that lead to their high discharge rates, high, surface area, low crystallinity and high electrical conductivity.

The battery system 100 may use plates, large spheres, cylinders or other large (1-1000 mm) rigid anode structures produced using various materials. The use of such materials allows the appropriate reaction of the anode 102, the separator 103, and cathode 104. The anodes 102 in various embodiments are produced by premixing aerogel or xerogel precursors with ceramic materials. The resulting mixture is then gelled and pyrolyzed to form composite materials suitable for use as carbon anodes. The addition of ceramic materials offer internal support to the carbon anode. Examples of effective ceramic materials include silica, alumino-silicates, ash derived from coal or petroleum clays, or glassy materials based on borates, phosphates, or silicates with alkaline earth or transition metal cations. In addition to aerogel and xerogel composites, pyrolyzed aerogels and pyrolyzed xerogels can be used alone as anode 102. These materials are particularly useful as rigid block anodes in batteries.

In various embodiments, the anode 102 is constructed of carbons prepared by sol-gel techniques. The reactivity of carbons in form of aerogel microspheres, aerogels or xerogels are expected to be general, regardless of whether they are prepared in particulate form, pellet form, or as a monolith. Carbon aerogels/xerogels are composed of covalently bonded, nanometer-sized particles that are arranged in a 3-dimensional network. These materials have high porosity (>50%) pores that are less than 100 nm in diameter, and have surface areas that range from 400 to 1000 m²/g and high electrical conductivity (25-100 S/cm). The pyrolysis of a resorcinol precursor in the presence of a catalyst is used to produce a variety of carbon materials. The ratio of resorcinol to catalyst will determine structural parameters, such as primary particle size and secondary aggregate size. Sol-gel derived carbon exhibits three properties that lead to their high discharge rates, high, surface area, low crystallinity and high electrical conductivity.

The anode 102 in various embodiments is produced by premixing aerogel or xerogel precursors with ceramic materials. The resulting mixture is then gelled and pyrolyzed to form composite materials suitable for use as carbon anodes. The addition of ceramic materials offer internal support to the carbon anode. Examples of effective ceramic materials include silica, alumino-silicates, ash derived from coal or petroleum clays, or glassy materials based on borates, phosphates, or silicates with alkaline earth or transition metal cations. In addition to aerogel and xerogel composites, pyrolyzed aerogels and pyrolyzed xerogels can be used alone as anode 102. These materials are particularly useful as rigid block anodes in carbon/air fuel cells and batteries.

### EXAMPLES

### Example 1

### Phenolic-Furfural Carbon Aerogel

An organic gel solution was prepared from a commercially available polymer solution (FurCarb UP520; QO Chemicals, Inc., West Lafayette, Ind., USA). This solution comprised approximately a 50:50 mixture of a phenolic novolak resin dissolved in furfuraldehyde. The FurCarb UP520 was diluted 50 wt. % with 1-propanol and 1 gr of phosphoric acid catalyst is added (a mixture of aromatic acid chlorides; Q2001; QO Chemicals, Inc., West Lafayette, Ind., USA). The solution was poured into glass vials, sealed and cured for 7 days at 85° C. The gels were removed from the vials and placed directly into a pressure vessel. The gels were then dried by super-critical extraction after exchange with liquid carbon dioxide in the pressure vessel at about 70 bars and 40° C. temperature for 6 hours. The dried gels were then heated in a furnace, under nitrogen flow, to a temperature of 1050° C. over about 70 minutes, maintained at 1050° C. for 4 hours, and then cooled at a rate of about 10° C./minute to form glassy-carbon monoliths.

### Example 2

### Monolithic Aerogel/Xerogel

An organic gel solution comprising 12.4 grams of resorcinol, 17.9 grams of 37% formaldehyde solution, 22.3 grams of 0.1 molar sodium carbonate and 45.3 grams of de-ionized water, is mixed and poured into a glass container. The container is sealed and then placed in an oven at a temperature of 80° C.; gelation occurs in about 120 minutes.

For an aerogel, the gel is removed from the glass container and placed in a stirred, acetone solvent bath for 24 hours. The gel is removed from the solvent bath and immediately placed in an acetone filled pressure vessel. The gel is dried by super-critical extraction after exchange of the acetone solvent with liquid carbon dioxide in the pressure vessel at about 60 bars and 40° C. temperature for 6 hours. The dried aerogel is then heated in a furnace to a temperature of 900° C. over about 60 minutes, maintained at 900° C. for 12 hours, and then cooled at a rate of about 10° C./minute to form a glassy-carbon monolith.

For a xerogel, the gel remains in the glass container which is partially sealed by placing a gas-permeable membrane over its opening. The gel slowly dries and shrinks over a period of about 40 days. The dried xerogel is then heated in a furnace to a temperature of 900° C. over about 60 minutes, maintained at 900° C. for 12 hours, and then cooled at a rate of about 10° C./minute to form a glassy-carbon monolith.

### Example 3

### Aerogel/Carbon Pre-Form Composite

An organic gel solution comprising 12.4 grams of resorcinol, 17.9 grams of 37% formaldehyde solution, 22.3 grams of 0.1 molar sodium carbonate and 45.3 grams of de-ionized water, is infiltrated into a preformed carbon fiber mat in a glass container; extra solution is added to completely cover the mat. The container is then placed in an oven at a temperature of 80° C.; gelation occurs in about 120 minutes. The composite gel is removed from the container and placed in an acetone solvent bath for 24 hours. The composite gel is then dried by super-critical extraction after exchange with liquid carbon dioxide in a pressure vessel at about 60 bars and 40° C. temperature for 6 hours. The dried composite is then heated in a furnace to a temperature of 900° C. over about 60 minutes, maintained at 900° C. for 12 hours, and then cooled at a rate of about 10° C./minute to form a glassy-carbon composite monolith.

### Example 4

### Aerogel/Carbon Fiber Composite

An organic gel solution comprising 12.4 grams of resorcinol, 17.9 grams of 37% formaldehyde solution, 22.3 grams of 0.1 molar sodium carbonate and 45.3 grams of de-ionized water, is mixed with 43 grams of carbon fibers in a 200 ml beaker. The beaker is placed in an ultrasonic water bath heated to 65° C. and sonicated at high intensity; gelation occurs in 150 minutes. The gel is placed in an oven at 80° C. for about 30 hours. The composite gel is cooled and removed from the beaker and placed in an acetone solvent bath for 24 hours. The composite gel is then dried by super-critical extraction after exchange with liquid carbon dioxide in a pressure vessel at about 60 bars pressure and 40° C. temperature for 6 hours. The dried composite is then heated in a furnace to a temperature of 1050° C. over about 70 minutes, maintained at 1050 ° C. for a 12 hours, and then cooled at a rate of about 10° C./minute to form a glassy-carbon composite monolith is formed.

Those skilled in the art can vary the above-listed examples using other organic gel precursors, other carbon-fiber mats or foams, and/or other carbon fiber varieties or particles, such as carbon fibers, carbon paper, carbon rods, carbon fabrics, carbon screens, and graphite or highly graphitized carbon.

Referring now to FIG. 2, an embodiment of a carbon fuel cell system constructed in accordance with the present invention is illustrated. The system is designated generally by the reference numeral 200. The system 200 comprises a fuel cell housing 201 containing an anode 205 and a cathode 206. An inert ceramic separator 207 (e.g., woven fabrics or felts comprised of alumina or zirconia fibers) saturated with the molten salt is located between anode 205 and cathode 206.

A paste, slurry or wetted aggregation of carbon 202 is introduced into the fuel cell housing 201. The paste, slurry, or wetted aggregation of carbon 202 comprises carbon 204 immersed in a molten-salt electrolyte 203 and contained within the anode chamber 214 portion of the cell housing 201. The fuel cell 200 utilizes carbon aerogel and/or xerogel fuels in a molten salt fuel cell. Carbon aerogels or xerogels are supplied to the fuel cell 201 (or to a battery) as microspheres, pulverized powder, pellets, or monolithic blocks of any chosen form. The carbon 204 is prepared by sol-gel techniques as efficient, high discharge rate anodes for the carbon fuel cell 201 or for batteries. The reactivity of carbon in form of aerogel microspheres, aerogels or xerogels is sufficient, regardless of whether they are prepared in particulate form, pellet form, or as a monolith. Carbon aerogels/xerogels are composed of covalently bonded, nanometer-sized particles that are arranged in a 3-dimensional network. These materials have high porosity (>50%) pores that are less than 100 nm in diameter, and have surface areas that range from 400 to 1000 m²/g and high electrical conductivity (25-100 S/cm). The pyrolysis of a resorcinol precursor in the presence of a catalyst is used to produce a variety of carbon materials. The ratio of resorcinol to catalyst will determine structural parameters, such as primary particle size and secondary aggregate size.

Molten carbonate salt (Li, K, Na; Mg, Ca, Sr, Ba) or mixtures thereof may be used as electrolyte 203. Cryolite, Na₃AlF₆, where Na may be replaced by one or more of the following elements: Li, K, Na; Mg, Ca, Sr, Ba, or other molten salts may potentially be used instead of the carbonate electrolyte. The fuel cell 201 uses a slurry of particulate carbon aerogel fuel 204 in a molten carbonate electrolyte (32% Li/68% K eutectic) 203 in the anode compartment 214 at a ratio of carbon to carbonate of 1:2 or less. The cell housing 201 can be made from alumina cylinders, with 300 ppi nickel foam/stainless steel screen composite electrodes. A 0.76 mm thick porous zirconia cloth separator 207 wetted with molten carbonate lay between the anode 205 and cathode 206. The cell 201 has electrode area of 2.8 cm². A mixture of carbon dioxide and air (to provide oxygen) is flowed through the cathode compartment at a ratio of 5 air: 2 CO₂ and a rate 1-10× stoichiometric. A slow flow of argon gas can be used at the anode to prevent air from entering the compartment, alternatively a sealed cell with provisions for CO₂ product gas outflow may be used.

For a carbon fuel in a molten carbonate fuel cell, the electrochemical reactions are:

| | | |
|---|---|---|
| Anodic half reaction: | C + 2CO₃²⁻ | • 3CO₂ + 4e⁻ |
| Cathodic half reaction: | O₂ + 2CO₂ + 4 e⁻ | • 2CO₃²⁻ |
| Overall cell reaction: | C + O₂ | • CO₂ |

Sol-gel derived carbon exhibits three properties that lead to their high discharge rates, high, surface area, low crystallinity and high electrical conductivity. X-ray diffraction data of a range of carbon materials, and the linewidth of the carbon aerogel microspheres is the broadest, indicating it is the least crystalline.

The slurry 202 is introduced into the fuel cell housing 201. The molten salt electrolyte 203 provides a continuous electrolyte of carbon particles 204 between the porous nickel plate anode current collector 205 and a porous nickel plate cathode 206. The anode current collector 205 and the cathode 206 produce an electrical potential between the anode lead 208 and the cathode lead 209, from which electrical current may be drawn by closing the circuit through a load. The fuel cell also provides ports for introduction of air plus carbon dioxide 210 and exhaust of air and unreacted carbon dioxide 211. The fuel cell also provides at least one port for exhaust of carbon dioxide reaction product, 212, from the anode chamber; and a drain 213 for the draining of excess molten carbonate from the anode chamber (or introducing additional molten carbonate into the system).

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. A fuel cell or battery apparatus, comprising:
a fuel cell or battery unit having an anode component that comprises an aerogel or xerogel.

2. The fuel cell or battery apparatus of claim 1 wherein said anode component comprises an aerogel or xerogel in particulate form, pellet form, or as a monolith.

3. The fuel cell or battery apparatus of claim 1 wherein said anode component comprises a carbon prepared by sol-gel techniques.

4. The fuel cell or battery apparatus of claim 1 wherein said anode component comprises a carbon aerogel or xerogel composed of covalently bonded, nanometer-sized particles that are arranged in a 3-dimensional network.

5. The fuel cell or battery apparatus of claim 1 wherein said anode component comprises a carbon aerogel or xerogel composed of covalently bonded, nanometer-sized particles that have high porosity (>50%) pores that are less than 100 nm in diameter, and have surface areas that range from 400 to 1000 m²/g and high electrical conductivity (25-100 S/cm).

6. The fuel cell or battery apparatus of claim 1 wherein said anode component comprises an anode component produced by the process of:
providing a solution of organic aerogel or xerogel precursors including at least one of a phenolic resin, phenol (hydroxybenzene), resorcinol (1,3-dihydroxybenzene), or catechol (1,2-dihydroxybenzene) and at least one aldehyde compound selected from the group consisting of formaldehyde, acetaldehyde, furfuraldehyde;
adding (1) ceramic materials; (2) glassy materials based on borates, phosphates, or silicates with alkaline earth or transition metal cations; and/or (3) carbon materials to said precursor solution to form a precursor mixture;
gelling said precursor mixture to form a composite gel;
drying said composite gel; and
pyrolyzing said composite gel to form an aerogel/carbon composite or a xerogel/carbon composite.

7. The fuel cell or battery apparatus of claim 6 wherein said drying is accomplished by supercritical-critical solvent extraction.

8. The fuel cell or battery apparatus of claim 6 wherein said drying is accomplished by air drying.

9. The fuel cell or battery apparatus of claim 6 wherein said ceramic materials are selected from the group consisting of silica, alumino-silicates, and ash derived from coal or petroleum clays.

10. The fuel cell or battery apparatus of claim 6 wherein said graphitic materials are selected from the group consisting of carbon fibers, carbon paper, carbon rods, carbon fabrics, carbon screens, graphite or highly graphitized carbon structures.

11. The fuel cell or battery apparatus of claim 6 wherein said aerogel is phenol-based, resorcinol-based, or catechol-based.

12. The fuel cell or battery apparatus of claim 6 wherein said xerogel is phenol-based, resorcinol-based, or catechol-based.
